(19) United States
(12) Patent Application Publication
(10) Pub. No.: US 2023/0146021 A1
(43) Pub. Date: May 11, 2023

(54) Pouch cell assembly

(71) Applicant: Hilti Aktiengesellschaft, Schaan (LI)

(72) Inventor: Johannes LANDESFEIND, Wielenbach (DE)

(21) Appl. No.: 17/802,293

(22) PCT Filed: Mar. 5, 2021
(86) PCT No.: PCT/EP2021/055549

§ 371 Date: Aug. 25, 2022

(30) Foreign Application Priority Data
Mar. 19, 2020 (EP) 20164192.5

(51) Int. Cl. H01M 50/578; H01M 50/105; H01M 50/211

(52) U.S. Cl. CPC H01M 50/578; H01M 50/105; H01M 50/211

(57) ABSTRACT

Pouch cell assembly with at least one pouch cell, the pouch cell assembly having at least one pressure-sensitive sensor film, in particular a pressure-sensitive conductive film (pressure-sensitive conductive sheet), which surrounds or delimits at least certain portions of the pouch cell in such a way that inflation of the pouch cell has the effect of compressing the sensor film and thereby changing an electrical resistance of the sensor film.

The present invention relates to a pouch cell assembly with at least one pouch cell.

### BACKGROUND

Pouch cell assemblies and pouch cells are known in principle from the prior art. The undesired phenomenon known as swelling, also referred to as expansion or inflation, is likewise known from the prior art. Gases are typically produced during the operation of lithium-ion cells. In the case of cell formats without a hard outer shell (for example pouch cells), this may have the effect that the originally present atmospheric pressure is lost and the performance of the cell suffers. If too much gas develops, the internal pressure of the cell may end up so high that the outer shell of the pouch cell bursts.

### SUMMARY OF THE INVENTION

It is an object of the present invention to provide a pouch cell assembly that provides the basis for increased operational safety.

The present invention provides a pouch cell assembly having at least one pressure-sensitive sensor film, in particular a pressure-sensitive conductive film (pressure-sensitive conductive sheet), which surrounds or delimits at least certain portions of the pouch cell in such a way that inflation of the pouch cell has the effect of compressing the sensor film and thereby changing an electrical resistance of the sensor film.

The filament provided according to the invention creates the basis for an effective detection or monitoring system by means of which swelling of one or more pouch cells in a pouch cell assembly and/or in a rechargeable battery pack can be determined. This allows bursting of the cell to be counteracted by early detection.

The invention includes the finding that conventional possibilities for detection, such as for example discrete pressure sensors, are impracticable because they are too expensive. According to the invention, a simple and comparatively low-cost pressure-sensitive sensor film, in particular a pressure-sensitive conductive film (pressure-sensitive conductive sheet), is used. Swelling of one or more pouch cells can preferably be detected by a change in the resistance of the sensor film when there is a buildup of pressure.

In a particularly preferred configuration, the sensor film is provided as a carbon black coated polymer film. The polymer film is preferably a polyethylene, polypropylene or polymethylpentene film. In a particularly preferred configuration, the sensor film has a sheet resistance of less than 4×10E5 Ohm/sq, preferably less than 1×10E5 Ohm/sq. In a particularly preferred configuration, the sheet resistance of the sensor film lies between 1×10E3 and 1×10E5 Ohm/sq. Particularly preferably, the sensor film has a lower sheet resistance in the compressed state than in the non-compressed state.

It has been found to be advantageous if the pouch cell assembly has a rigidly formed frame. The sensor film is preferably supported on the one hand against the frame and on the other hand against the pouch cell. The rigidly formed frame advantageously forms a “counter stop”, so that any pressure introduced into the sensor film from a swelling pouch cell is intensified.

In a particularly preferred configuration, the pouch cell assembly has a pressure equalizing element, which is arranged in a sandwich-like manner at least between the pouch cell and the sensor film. Alternatively or in addition, the sensor film may be embedded in the pressure equalizing element. Alternatively or in addition, the pressure equalizing element may be positioned between the frame and the sensor film. It has been found to be advantageous if the pressure equalizing element is provided as a pressure equalizing film. A pressure equalizing element can advantageously have the effect of preventing an uneven pressure on a pouch cell, and thus of reducing accelerated aging of the cell.

In a particularly preferred configuration, a plurality of sensor films are provided. These are preferably arranged at various positions of the pouch cell in order to obtain additional information concerning a distribution of pressure over a cell surface of the pouch cell.

In a particularly preferred configuration, the sensor film is part of an aluminum composite film of the pouch cell assembly. In other words, the sensor film may be integrated in a “conventional” aluminum composite film (for example polyamide/aluminum/polypropylene). Advantageously, the sensor film can thus be incorporated synergetically during cell assembly (thermoforming and welding of the aluminum composite film), specifically as part of the aluminum composite film itself. It has been found to be advantageous if the pouch cell is welded into the aluminum composite film.

In a particularly preferred configuration, the pouch cell assembly is assigned a sensor circuit by means of which compressing of the sensor film can be detected. The sensor circuit is preferably designed to evaluate electrically a change in resistance (preferably sheet resistance) of the sensor film, the sensor film having a lower sheet resistance in the compressed state (swollen pouch cell) than in the non-compressed state (pouch cell in the new state). The sensor circuit may be designed to monitor a change in resistance of the pouch cell continuously or only at certain intervals (during operation, at rest, during charging etc.). The sensor circuit may be enclosed by the pouch cell assembly.

In a further particularly preferred configuration, the pouch cell assembly is assigned a control circuit, which interrupts or reduces drawing of current from the pouch cell assembly or the pouch cell if the sensor circuit has detected compressing of the sensor film. The control circuit may be enclosed by the pouch cell assembly.

The sensor circuit and/or the control circuit may be part of a battery management system (BMS) of an electric hand-held power tool. It has been found to be advantageous if the sensor circuit transmits any measurement data (such as for example the sheet resistance of the sensor film) to the control circuit in a form in which it is averaged over time or filtered, so that for example unintentional switching off (for example swelling of the pouch cell just for a time due to it being transported by aircraft for a time) of the pouch cell assembly can be prevented.

It has been found to be advantageous if the pouch cell assembly has a plurality of pouch cells, which are preferably surrounded or delimited in each case at least by a sensor film of their own. Alternatively, the pouch cell assembly may have a plurality of pouch cells to which a common sensor film is assigned. The sensor film may be arranged above and/or between the pouch cells.

The pouch cell is preferably a rechargeable lithium-ion battery. A pouch cell may contain one or more individual cells.

According to a further aspect of the invention, a rechargeable battery pack for an electric hand-held power tool is provided, the rechargeable battery pack being equipped with at least one pouch cell assembly of the type described above.

Subject matter that can be protected independently is the use of a sensor film, in particular a pressure-sensitive conductive film (pressure-sensitive conductive sheet), as a pouch film of a pouch cell assembly, the sensor film preferably being part of an aluminum composite film. This subject matter that can be protected independently can be developed by the features described with reference to the pouch cell assembly in a corresponding way.

### BRIEF DESCRIPTION OF THE DRAWINGS

Further advantages can be found in the following description of the figures. Various exemplary embodiments of the present invention are illustrated in the figures. The figures, the description and the claims contain numerous features in combination. A person skilled in the art will expediently also consider the features individually and combine them to form useful further combinations.

In the figures, identical and similar components are denoted by the same reference signs. In the figures:

FIGS. 1A), 1B) and 1C) show a first preferred exemplary embodiment of a pouch cell assembly according to the invention;

FIG. 2 shows a second preferred exemplary embodiment of a pouch cell assembly according to the invention;

FIG. 3 shows a third preferred exemplary embodiment of a pouch cell assembly according to the invention; and

FIG. 4 shows a fourth preferred exemplary embodiment of a pouch cell assembly according to the invention.

### DETAILED DESCRIPTION

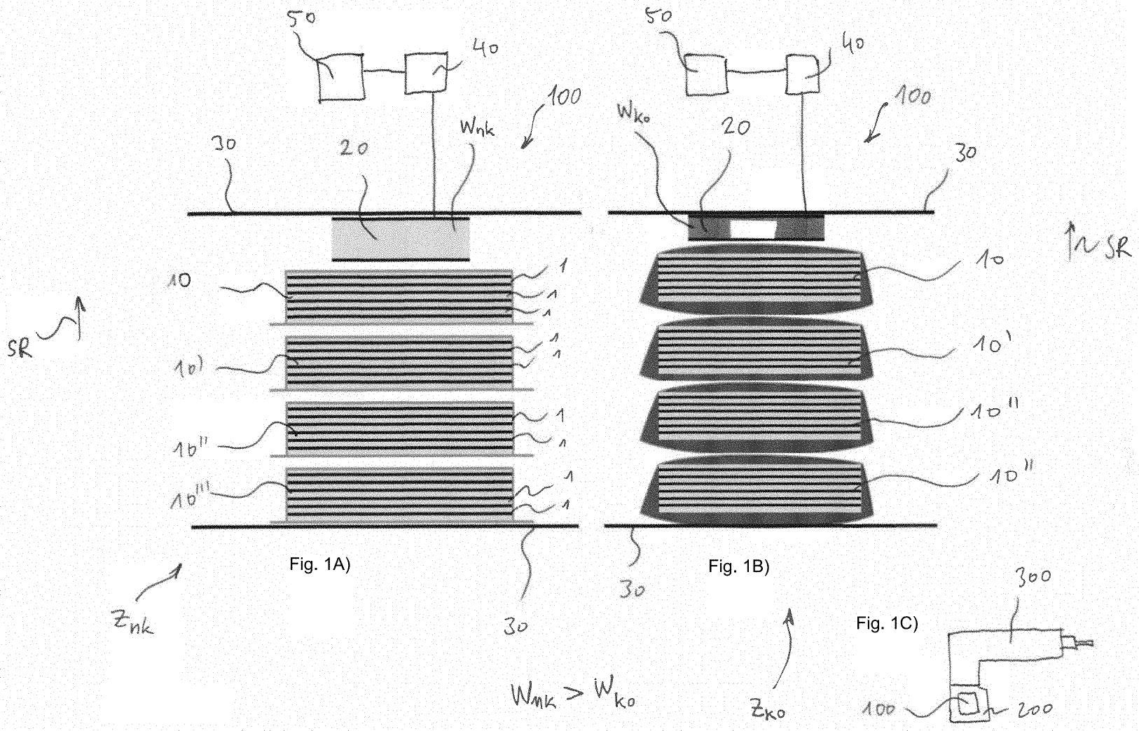

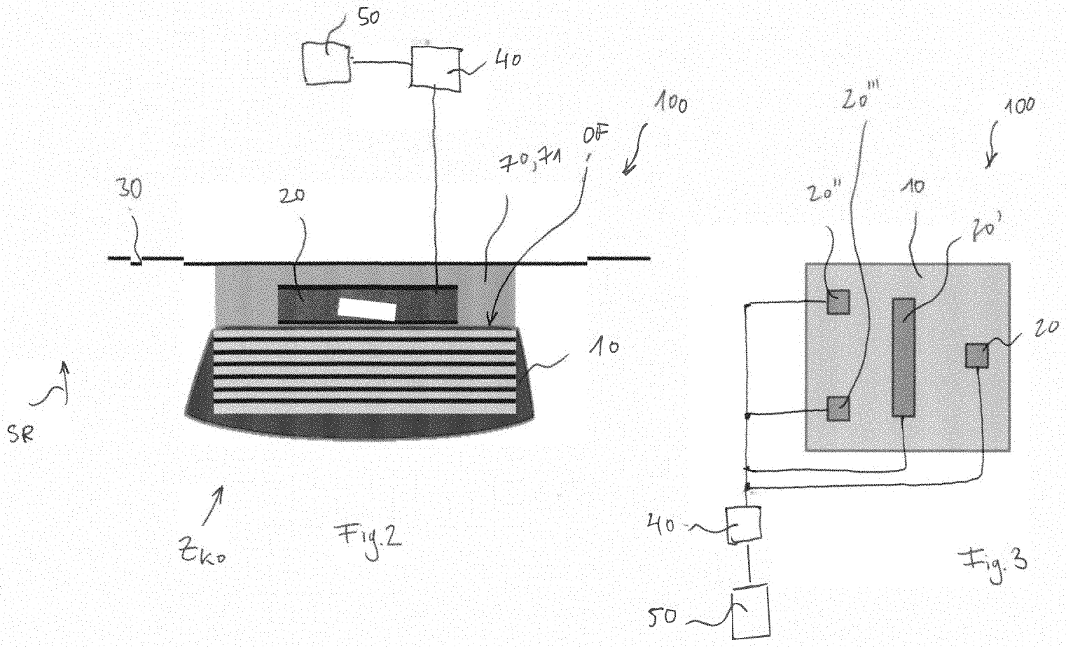

A first preferred exemplary embodiment of a pouch cell assembly 100 according to the invention is illustrated in FIGS. 1A), 1B) and 1C). As can be seen in FIGS. 1A) and 1B), the pouch cell assembly 100 has a plurality of pouch cells 10, 10′, 10″, 10″′. FIG. 1A) shows the pouch cells 10, 10′, 10″, 10′″ in the normal state, i.e. they are not inflated, or at most very little. FIG. 1B) on the other hand shows the pouch cells 10, 10′, 10″, 10′″ in the undesired inflated state (with respect to the stacking direction SR). The pouch pouch cells 10, 10′, 10″, 10″′ have in each case a plurality of individual cells 1, which are stacked here in a sandwich-like manner.

By way of example, the pouch cell assembly 100 is part of a rechargeable battery pack 200 of an electric hand-held power tool 300, which is illustrated in a simplified form in FIG. 1C).

According to the invention, the pouch cell assembly 100 has at least one pressure-sensitive sensor film 20, which is provided here by way of example as a pressure-sensitive conductive film (pressure-sensitive conductive sheet). At least certain portions of the uppermost pouch cell 10 are delimited by the sensor film 20, so that inflation of the pouch cell 10 has the effect of compressing the sensor film 20 in the stacking direction SR. The pouch cell assembly 100 has a rigidly formed frame 30, the sensor film 20 being supported on the one hand against the frame 30 and on the other hand against the uppermost pouch cell 10. The lowermost pouch cell 10′″ is likewise supported against the frame 30. The rigidly formed frame consequently forms a “counter stop”, so that any pressure introduced into the sensor film 20 from a swelling pouch cell 10, 10′, 10″, 10′″ is intensified. In the present case, the pouch cell assembly 100 therefore has a plurality of pouch cells 10, 10′, 10″, 10′″, to which the common sensor film 20 is assigned.

The introduction of pressure into the sensor film 20 causes an electrical resistance of the sensor film 20 to change. The sensor film 10 has a lower sheet resistance in the compressed state (FIG. 1B) than in the non-compressed state (FIG. 1A). The sheet resistance Wnk in the non-compressed state Znk is greater than the sheet resistance Wko in the non-compressed state Zko.

The pouch cell assembly 100 is assigned a sensor circuit 40, by means of which compressing of the sensor film 20 can be detected. The sensor circuit 40 is in this case designed to evaluate electrically a change in sheet resistance of the sensor film 40, the sensor film 40 having a lower sheet resistance Wko in the compressed state (FIG. 1B) than in the non-compressed state (FIG. 1A).

The pouch cell assembly 100 is likewise assigned a control circuit 50, which interrupts or reduces drawing of current from the pouch cell assembly 100 or the pouch cell 10 if the sensor circuit 40 has detected compressing of the sensor film 20. The control circuit 50 becomes active if the sheet resistance of the sensor film 40 goes below a prespecified threshold value.

A second preferred exemplary embodiment of a pouch cell assembly 100 according to the invention with a sensor film 20 is illustrated in FIG. 2. Certain portions of the pouch cell 10 are delimited by the sensor film 20, so that inflation of the pouch cell 10 has the effect of compressing the sensor film 20 in the stacking direction SR. In order to ensure even pressure on the surface OF of the pouch cell 10, a pressure equalizing element 70 is provided, arranged in a sandwich-like manner between the pouch cell 10 and the sensor film 20, the sensor film 20 likewise being embedded in the pressure equalizing element 70. By way of example, the pressure equalizing element 70 is provided as a pressure equalizing film 71.

Also in the case of the exemplary embodiment of FIG. 2, the pouch cell assembly 100 has a rigidly formed frame 30, the sensor film 20 being supported on the one hand against the frame 30—this being indirectly by way of the pressure equalizing element 70—and on the other hand against the pouch cell 10.

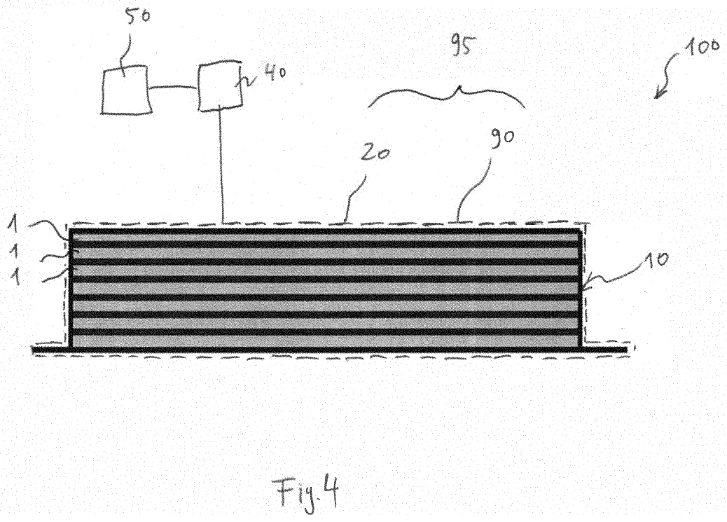

A third preferred exemplary embodiment of a pouch cell assembly 100 according to the invention is illustrated in FIG. 3. In FIG. 3, the pouch cell 10 is illustrated in a plan view. As can be seen in FIG. 3, a number of sensor films 20, 20′, 20″, 20′″ of different sizes and in different positions are provided on the surface OF of the pouch cell 10. This is in order to obtain detailed information concerning a distribution of pressure on the surface OF of the pouch cell 10. All of the sensor films 20, 20′, 20″, 20′″ are electrically connected to a sensor circuit 40, by means of which compressing of the sensor film 20 can be detected. The sensor circuit 40, which is designed to evaluate electrically a change in sheet resistance of the sensor film 40, is in turn connected to a common control circuit 50, by way of which the pouch cell 10 can be deactivated as and when required.

A fourth preferred exemplary embodiment of a pouch cell assembly 100 according to the invention with at least one pouch cell 10 is illustrated in FIG. 4. The pouch cell 1 has for its part a plurality of individual cells 1, which are stacked here in a sandwich-like manner. The individual cells 1 are welded into an aluminum composite film 90—illustrated in FIG. 4 by dashed lines. Likewise provided is a sensor film 20, which by way of example is provided as a pressure-sensitive conductive film (pressure-sensitive conductive sheet) and is integrated in the aluminum composite film 90 itself. By way of example, here the aluminum composite film 90 is a polyamide-aluminum-polypropylene composite film, with a carbon black coating applied to the polypropylene layer, providing the effect of the pressure dependence of the sheet resistance of the sensor film 20. The aluminum composite film 90 with an integrated sensor film 20 defined a common pouch film 95. Detection of the sheet resistance of the sensor film 20 takes place by way of the sensor circuit 40. By means of the control circuit 50, a desired action can be brought about, for example reducing drawing of current from the pouch cell assembly 100.

FIG. 4 consequently shows the use of a sensor film 20, in the form of a pressure-sensitive conductive film (pressure-sensitive conductive sheet), as a pouch film 95 of a pouch cell assembly 100, the sensor film 20 being part of an aluminum composite film 90.

### LIST OF REFERENCE SIGNS

1 Individual cell
10, 10′, 10″, 10′″ Pouch cells
20, 20′, 20″, 20′″ Sensor films
30 Frame
40 Sensor circuit
50 Control circuit
70 Pressure equalizing element
71 Pressure equalizing film
90 Aluminum composite film
95 Pouch film
100 Pouch cell assembly
200 Rechargeable battery pack
300 Electric hand-held power tool
OF Surface
SR Stacking direction
Wnk Sheet resistance in the non-compressed state
Wko Sheet resistance in the compressed state
Znk Non-compressed state
Zko Compressed state

What is claimed is:

1-11. (canceled)

12. A pouch cell assembly comprising:
at least one pouch cell;
at least one pressure-sensitive sensor film surrounding or delimiting at least certain portions of the at least one pouch cell in such a way that inflation of the at least one pouch cell compresses the sensor film so as to change an electrical resistance of the sensor film.

13. The pouch cell assembly as recited in claim 12 further comprising a rigidly formed frame, the at least one sensor film being supported on one side against the frame and against the pouch cell on an other side.

14. The pouch cell assembly as recited in claim 12 further comprising a pressure equalizing element sandwiched between the pouch cell and the at least one sensor film.

15. The pouch cell assembly as recited in claim 12 wherein the at least one sensor film includes a plurality of sensor films.

16. The pouch cell assembly as recited in claim 12 wherein the at least one sensor film is part of an aluminum composite film, the pouch cell being welded into the aluminum composite.

17. The pouch cell assembly as recited in claim 12 further comprising a sensor circuit, a compressing of the sensor film detectable by the sensor circuit.

18. The pouch cell assembly as recited in claim 17 wherein the sensor circuit is enclosed by the pouch cell assembly.

19. The pouch cell assembly as recited in claim 12 further comprising a control circuit interrupting or reducing drawing of current from the pouch cell assembly or the at least one pouch cell if the sensor circuit has detects compressing of the sensor film.

20. The pouch cell assembly as recited in claim 17 wherein the control circuit is enclosed by the pouch cell assembly.

21. The pouch cell assembly as recited in claim 12 wherein the at least one pouch cell includes a plurality of pouch cells surrounded or delimited in each case by one of the at least one sensor film.

22. The pouch cell assembly as recited in claim 12 wherein the at least one pouch cell includes a plurality of pouch cells, the at least one sensor film including a common sensor film assigned to the plurality of pouch cells

23. The pouch cell assembly as recited in claim 12 wherein the at least one pressure-sensitive sensor film is a pressure-sensitive conductive film.

24. A rechargeable battery pack of an electric hand-held power tool comprising the pouch cell assembly as recited in claim 12.

25. A method comprising employing a sensor film as a pouch film of a pouch cell assembly.

26. The method as recited in claim 25 wherein the sensor film is being part of an aluminum composite film.

27. The method as recited in claim 25 wherein the sensor film is a pressure-sensitive conductive film.
